(19) United States
(12) Patent Application Publication
(10) Pub. No.: US 2013/0071552 A1
(43) Pub. Date: Mar. 21, 2013

(54) BATTERY ELECTRODE MANUFACTURING METHOD AND BATTERY MANUFACTURING METHOD

(71) Applicants: Kuniko TERAKI, Kyoto (JP); Kenta HIRAMATSU, Kyoto (JP); Takeshi MATSUDA, Kyoto (JP); Koji FURUICHI, Kyoto (JP); Masakazu SANADA, Kyoto (JP)

(72) Inventors: Kuniko TERAKI, Kyoto (JP); Kenta HIRAMATSU, Kyoto (JP); Takeshi MATSUDA, Kyoto (JP); Koji FURUICHI, Kyoto (JP); Masakazu SANADA, Kyoto (JP)

(21) Appl. No.: 13/556,686

(22) Filed: Jul. 24, 2012

(30) Foreign Application Priority Data
Sep. 20, 2011 (JP) 2011-204943

(51) Int. Cl. H01M 4/04

(52) U.S. Cl. 427/58

(57) ABSTRACT

In a technology for manufacturing a battery electrode by applying an application liquid containing an active material, stripe-shaped pattern elements are formed at narrower intervals than before while contact between the pattern elements is avoided. While a nozzle 21 including a multitude of discharge openings in an X-direction is moved to scan in a Y-direction relative to a base material 110, an application liquid containing an active material is discharged from the respective discharge openings and applied to the base material 110. Between pattern elements 221 formed by a first scanning movement, pattern elements 222 are formed by applying the application liquid anew by a second scanning movement. By making the start positions of the pattern elements 221, 222 different in a scanning direction (Y-direction), contact between the pattern elements resulting from the spread of the application liquid at pattern element start ends is prevented.

### CROSS REFERENCE TO RELATED APPLICATION

The disclosure of Japanese Patent Application No. 2011-204943 filed on Sep. 20, 2011 including specification, drawings and claims is incorporated herein by reference in its entirety.

### BACKGROUND OF THE INVENTION

1. Field of the Invention

This invention relates to a method for manufacturing a battery electrode by applying an application liquid containing an active material to a base material and a method for manufacturing a battery using the electrode.

2. Description of the Related Art

As a method for producing a chemical battery such as a lithium-ion secondary battery, the applicant of this application previously disclosed a technology for forming one electrode by applying an application liquid containing an active material in stripes on a surface of a base material, which will become a current collector, and laminating an electrolyte layer and another electrode on the one electrode (JP2011-070788A). In this technology, by a nozzle-scan coating method for moving and scanning a nozzle including discharge openings for discharging an application liquid relative to the base material surface, the application liquid containing the active material is applied to the base material surface from the nozzle in which a multitude of discharge openings are arranged in a predetermined direction to form a multitude of stripe-shaped active material pattern elements parallel to each other.

In the nozzle-scan coating method for discharging the application liquid while the nozzle is moved to scan relative to the base material surface, the application liquid discharged from the discharge openings and adhered to the base material spreads around at the start of application and, finally, pattern element start ends may become wider than other parts.

On the other hand, higher density of active material pattern elements is also required to further improve battery performance, more specifically, battery capacity and charge/discharge characteristics, and it is necessary to narrow intervals between parallel pattern elements. In this case, in the above conventional technology, there is a possibility that the adjacent pattern elements touch each other due to the spread of the application liquid at the start of application and it is difficult to deal with such a request as to increase the density of the pattern elements. In this respect, there is a room for improvement in the above conventional technology.

### SUMMARY OF THE INVENTION

This invention was developed in view of the above problem, an object thereof is to provide a technology capable of contributing to an improvement in battery performance by forming stripe-shaped pattern elements at narrower intervals than before while avoiding contact between the pattern elements in a technology for manufacturing a battery electrode by applying an application liquid containing active material.

To achieve the above object, the present invention is a battery electrode manufacturing method for manufacturing a battery electrode in which a plurality of stripe-shaped active material pattern elements parallel to each other are arranged on a surface of a base material, comprising: a first application step of applying an application liquid containing an active material in a stripe on the surface of the base material by moving and scanning a nozzle for discharging the application liquid in a predetermined scanning direction relative to the surface of the base material, thereby forming a first active material pattern element; and a second application step of applying an application liquid containing an active material in a stripe by moving and scanning a nozzle for discharging the application liquid in the scanning direction relative to the surface of the base material, thereby forming a second active material pattern element adjacent to the first active material pattern element, wherein a start position of the first active material pattern element and a start position of the second active material pattern element are made different in the scanning direction.

In the thus configured invention, the start positions are made different from each other in the scanning direction between the first and second active material pattern elements adjacent to each other. Thus, even if start end parts of the respective first and second active material pattern elements spread wider than a supposed-to-be pattern element width, a possibility of contact of the both pattern elements is reduced as compared with a case where the respective start positions are located at the same position in the scanning direction. It seems that there is a little problem when the adjacent active material pattern elements are merely in contact only at start end parts thereof. However, realistically, if the adjacent pattern elements touch each other at the start end parts, a wide pattern element is often formed with the both pattern elements kept united by a movement of the nozzle relative to the base material. Thus, the shape and surface area of the active material pattern elements become different from desired ones, wherefore expected battery performance cannot be obtained.

In the invention, a probability of contact between the pattern elements is reduced by making the start positions of the adjacent pattern elements different in the scanning direction. Thus, it is possible to form active material pattern elements, which are a plurality of adjacent stripe-shaped pattern elements at narrower intervals than before, while avoiding contact between the pattern elements.

Note that, in this invention, contact between the active material pattern elements adjacent to each other is prevented. Thus, the adjacent active material pattern elements are not limited to those of the same type and may have different compositions. For example, active material pattern elements for a positive electrode and those for a negative electrode may be alternately arranged on the base material. In this sense, the application liquid used in the first application step and that used in the second application step in the invention are not limited to the same application liquid.

Another aspect of the invention is a battery manufacturing method for manufacturing a battery, comprising: an electrode manufacturing step of manufacturing an electrode by the battery electrode manufacturing method described above; and an electrolyte layer forming step of forming an electrolyte layer covering the active material pattern elements by applying an application liquid containing an electrolyte material to a surface of the electrode where the active material pattern elements are formed.

In the thus configured invention, a battery is manufactured by laminating another functional layer through application on an electrode free from contact between the adjacent pattern elements as described above and including stripe-shaped active material pattern elements arranged at narrow intervals. That is, according to this invention, it is possible to manufacture a high-performance battery including an active material layer formed by stripe-shaped pattern elements arranged at a high density and having a large surface area.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1A and FIG. 1B are drawings which show an example of a battery manufactured by using the present invention;

FIG. 2 is a flow chart which shows a manufacturing method of the embodiment for manufacturing the battery module;

FIG. 3A and FIG. 3B are drawings which show a state of application by the nozzle-scan coating method;

FIGS. 4A to 4D are diagrams which show a problem which can occur when the pattern element interval is made smaller;

FIGS. 5A and 5B are diagrams which show an example of the active material pattern elements in this embodiment;

FIGS. 6A and 6B are views which show a first example and a second example of pattern element formation according to this embodiment;

FIGS. 7A and 7B are views which show a third example of pattern element formation according to this embodiment; and

FIGS. 8A and 8B are views which show a fourth example of pattern element formation according to this embodiment.

### DETAILED DESCRIPTION OF THE PREFERRED EMBODIMENTS

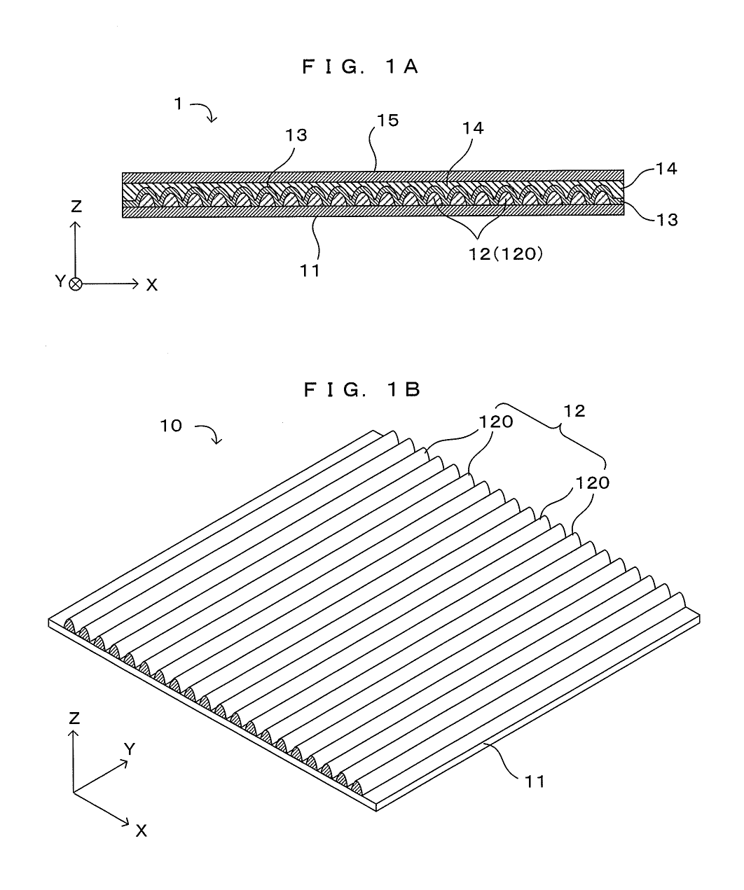

FIG. 1A and FIG. 1B are drawings which show an example of a battery manufactured by using the present invention. More specifically, FIG. 1A shows a cross-sectional structure of a lithium-ion battery module manufactured by an embodiment of the battery manufacturing method according to the invention. FIG. 1B is a schematic diagram which shows a structure of an electrode, which is manufactured by the battery electrode manufacturing method according to the invention, of the battery in FIG. 1A. This lithium-ion battery module 1 has such a structure that a negative-electrode active material layer 12, a solid electrolyte layer 13, a positive-electrode active material layer 14 and a positive-electrode current collector 15 are successively laminated on a surface of a negative-electrode current collector 11. In this specification, X-, Y- and Z-coordinate directions are respectively defined as shown in FIG. 1A.

FIG. 1B shows a structure of a negative electrode 10 formed by laminating the negative-electrode active material layer 12 on the surface of the negative-electrode current collector 11. As shown in FIG. 1B, the negative-electrode active material layer 12 has a line-and-space structure (striped structure) in which a multitude of stripe-shaped pattern elements 120 extending in a Y-direction are arranged at regular intervals in an X-direction. On the other hand, the solid electrolyte layer 13 is a thin film which is formed by a solid electrolyte and has an approximately constant thickness. The solid electrolyte layer 13 uniformly covers the substantially entire upper surface of the electrode 10 in such a manner as to conform to the unevenness on the surface of the electrode 10 in which the negative-electrode active material layer 12 is formed on the negative-electrode current collector 11 as described above.

The lower surface of the positive-electrode active material layer 14 has an uneven structure in conformity with the unevenness on the upper surface of the solid electrolyte layer 13, whereas the upper surface thereof is a substantially flat surface. The positive-electrode current collector 15 is laminated on the upper surface of the positive-electrode active material layer 14, whereby the lithium-ion secondary battery module 1 is formed. A lithium-ion battery is formed by appropriately arranging tab electrodes or laminating a plurality of modules on this lithium-ion battery module 1.

Here, known materials for lithium-ion batteries can be used as materials for the respective layers. For example, a copper foil and an aluminum foil can be respectively used as the negative-electrode current collector 11 and the positive-electrode current collector 15. Further, a material mainly containing LiCoO₂ (LCO) can be, for example, used as a positive-electrode active material and a material mainly containing Li₄Ti₅O₁₂ (LTO) can be, for example, used as a negative-electrode active material. Furthermore, a mixture of polyethylene oxide and polystyrene can be, for example, used as the solid electrolyte layer 13. Note that the materials for the respective functional layers are not limited to these.

The lithium-ion secondary battery module 1 having such a composition and structure is thin and flexible. Since the negative-electrode active material layer 12 is formed to have an uneven space structure as shown and, thereby, increase its surface area with respect to its volume, an area facing the positive-electrode active material layer 14 via the thin solid electrolyte layer 13 can be increased to ensure high efficiency and high output. In this way, the lithium-ion secondary battery having the above structure can be small in size and have high performance.

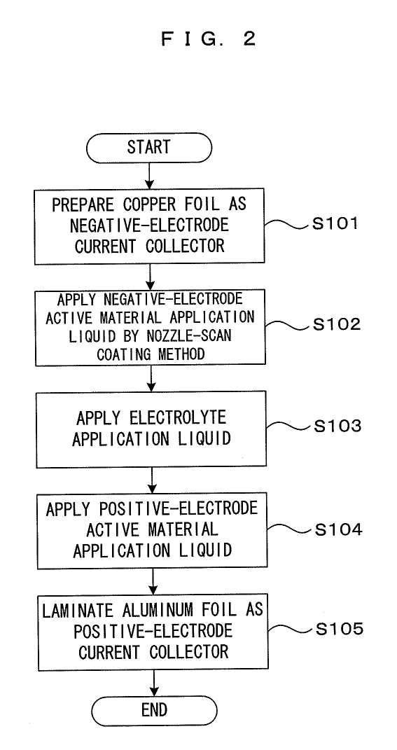

FIG. 2 is a flow chart which shows a manufacturing method of the embodiment for manufacturing the battery module. In this manufacturing method, a metal foil, e.g. a copper foil, which will become the negative-electrode current collector 11, is first prepared (Step S101). In the case of using a thin copper foil, it is difficult to transport and handle this foil. Accordingly, it is preferable to improve transportability, for example, by attaching one surface of the copper foil to a carrier such as a glass plate or a resin sheet.

Subsequently, an application liquid containing a negative-electrode active material is applied to one surface of the copper foil by a nozzle dispensing method, in particular, by a nozzle-scan coating method for relatively moving a nozzle for dispensing the application liquid with respect to an application target surface (Step S102). An organic LTO material containing the negative-electrode active material described above can be, for example, used as the application liquid. A mixture of the above negative-electrode active material, acetylene black or ketjen black as a conduction aid, polyvinylidene fluoride (PVDF), styrene butadiene rubber (SBR), polyvinyl pyrrolidone (PVP), polyvinyl alcohol (PVA) or polytetrafluoroethylene (PTFE) as a binder, N-methyl-2-pyrrolidone (NMP) as a solvent and the like can be used as the application liquid. Note that, besides LTO described above, graphite, metal lithium, SnO₂, alloys and the like can be used as the negative-electrode active material.

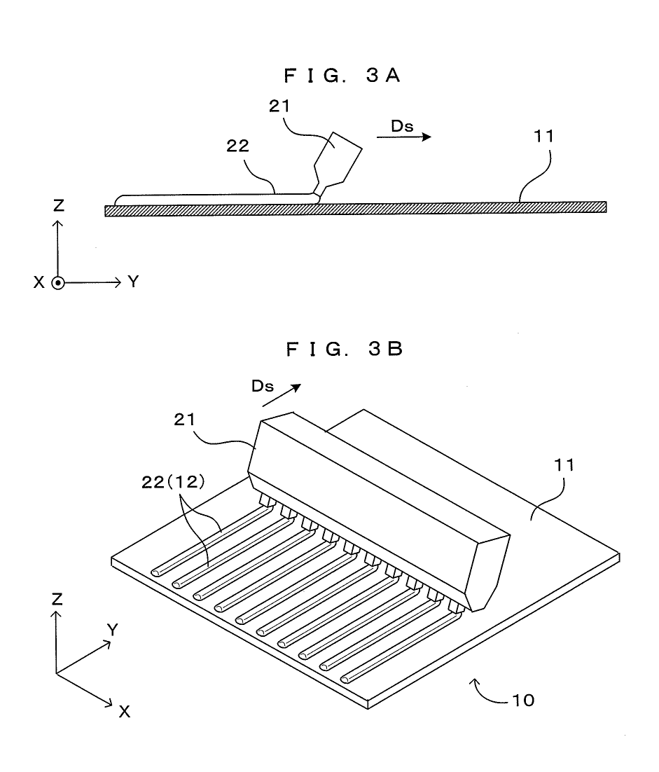

FIG. 3A and FIG. 3B are drawings which show a state of application by the nozzle-scan coating method. More specifically, FIG. 3A is a drawing which shows a side view of the state of application by the nozzle-scan coating method. FIG. 3B is a drawing which shows the same state when viewed from a diagonal upper side. A technology for applying an application liquid to a base material by the nozzle-scan coating method is known and such a known technology can be applied also in this method, wherefore an apparatus construction is not described.

In the nozzle-scan coating method, a nozzle 21 perforated with one or more dispense openings is arranged above a copper foil 11. The nozzle 21 is relatively moved at a constant speed in an arrow direction Ds with respect to the copper foil 11 while dispensing a fixed amount of an application liquid 22 from the dispense opening(s). By doing so, the application liquid 22 is applied on the copper foil 11 in a stripe extending in the Y-direction. By providing the nozzle 21 with a plurality of dispense openings, a plurality of stripes can be formed by one movement. By repeating this movement according to need, the application liquid can be applied in stripes on the entire surface of the copper foil 11. By drying and curing the application liquid, the negative-electrode active material layer 12 is formed on the upper surface of the copper foil 11. A photo-curable resin may be added to the application liquid and the application liquid may be cured by light irradiation after application.

At this point of time, an active material layer 12 is partly raised on the substantially flat surface of the copper foil 11. Thus, as compared with the case where the application liquid is simply applied to have a flat upper surface, a surface area can be increased with respect to the used amount of the active material. Therefore, the area facing a positive-electrode active material layer to be formed later can be increased to ensure a high output.

The flow chart of FIG. 2 is further described. An electrolyte application liquid is applied on the upper surface of a laminated body, which is formed by laminating the negative-electrode active material layer 12 on the copper foil 11, by an appropriate coating method, e.g. a knife coating method or a bar coating method (Step S103). As the electrolyte application liquid, a mixture of a resin as the above polymer electrolyte material such as polyethylene oxide and polystyrene, a supporting salt such as LiPF₆ (lithium hexafluorophosphate) and a solvent such as diethylene carbonate can be used.

The positive-electrode active material layer 14 is formed on a laminated body formed by laminating the copper foil 11, the negative-electrode active material layer 12 and the solid electrolyte layer 13 in this way (Step S104). The positive-electrode active material layer 14 is formed by applying a positive-electrode active material application liquid containing a positive-electrode active material by an appropriate coating method, e.g. a known knife coating method. An aqueous LCO material obtained by mixing the positive-electrode active material, acetylene black as a conduction aid, SBR as a binder, carboxymethylcellulose (CMC) as a dispersant and pure water as a solvent can be, for example, used as the application liquid containing the positive-electrode active material. Besides the above LCO, LiNiO₂, LiFePO₄, LiMnPO₄, LiMn₂O₄ or compounds represented by LiMeO₂ (Me=MₓM_{y}M_{z}; Me, M are transition metal elements and x+y+z=1) such as LiNi_{1/3}Mn_{1/3}Co_{1/3}O₂ and LiNi_{0.8}Co_{0.15}Al_{0.05}O₂ can be used as the positive-electrode active material. Further, known coating methods capable of forming a flat film on a flat surface such as the knife coating method, a bar coating method and a spin coating method can be appropriately employed as the coating method.

By applying the application liquid containing the positive-electrode active material to the laminated body, the positive-electrode active material layer 14 which has a lower surface conforming to the unevenness on the surface of the electrolyte layer 13 and a substantially flat upper surface is formed. A metal foil, e.g. an aluminum foil which will become a positive-electrode current collector 15 is laminated on the upper surface of the positive-electrode active material layer 14 formed in this way (Step S105). At this time, it is desirable to superimpose the positive-electrode current collector 15 on the upper surface of the positive-electrode active material layer 14 formed in previous Step S104 before the positive-electrode active material layer 14 is cured. By doing so, the positive-electrode active material layer 14 and the positive-electrode current collector 15 can be tightly bonded to each other. Since the upper surface of the positive-electrode active material 14 is leveled, the positive-electrode current collector 15 can be easily laminated without forming any clearance. By doing so, the lithium-ion battery module 1 shown in FIG. 1A can be manufactured.

The above method for manufacturing a lithium-ion battery is basically the same as that disclosed in JP2011-070788 described above. However, in this embodiment, a step of forming the negative-electrode active material layer 12 in Step S102 is configured as follows to increase the density of the active material pattern elements 120 in the negative-electrode active material layer 12 by making the intervals between the multitude of stripe-shaped active material pattern elements 120 smaller than before.

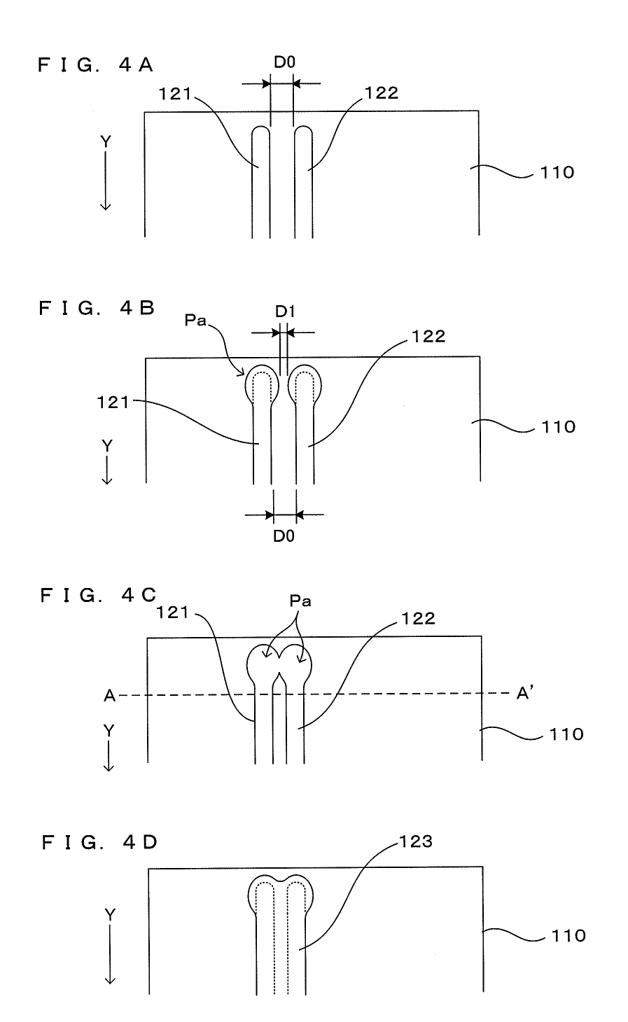

FIGS. 4A to 4D are diagrams which show a problem which can occur when the pattern element interval is made smaller. Although a case where two active material pattern elements 121, 122 are formed on the base material 110 is illustrated here, the same idea applies also in the case where the number of the pattern elements is larger than this. In the case of forming these two pattern elements 121, 122 by application, it is desirable to form two pattern elements 121, 122 having a fixed pattern element width and in parallel to each other while defining a constant interval D0 as shown in FIG. 4A. However, in the nozzle-scan coating method for applying the application liquid to the base material 110 by discharging the application liquid from the nozzle 21 moving relative to the base material 110, the width of a pattern element start end Pa may be wider than it is supposed to be as shown in FIG. 4B due to the stay of the application liquid at the opening of the nozzle 21 at the start of application and a relationship between a scanning movement and an operation start timing. That is, an interval D1 at the pattern element start ends tends to be smaller than the supposed-to-be interval D0.

Here, if it is thought to make the pattern element interval smaller than before, the adjacent pattern elements 121, 122 may touch each other due to the spread of the pattern element start ends Pa as shown in FIG. 4C. Since the pattern elements 121, 122 are both negative-electrode active material pattern elements on the negative-electrode current collector of the lithium-ion battery, even if they merely touch each other only at the start ends Pa to be electrically shorted, it is not a fatal problem in the operation of the battery. For example, as shown by broken line A-A′ in FIG. 4C, there is no particular problem if pattern element start end parts are cut off together with the base material 110 and not used as the battery.

However, realistically, once contact is established at the pattern element start ends, it is not easy to separate the two pattern elements again due to the surface tension of the application liquid. As the nozzle discharging the application liquid corresponding to each pattern element is moved to scan, a pattern element 123 is formed with two stripes of the application liquid, which are supposed to be separate, united as shown in FIG. 4D. Thus, the shape such as the pattern element width and surface area becomes different from a desired one, which leads to a variation in the performance of the battery using this electrode.

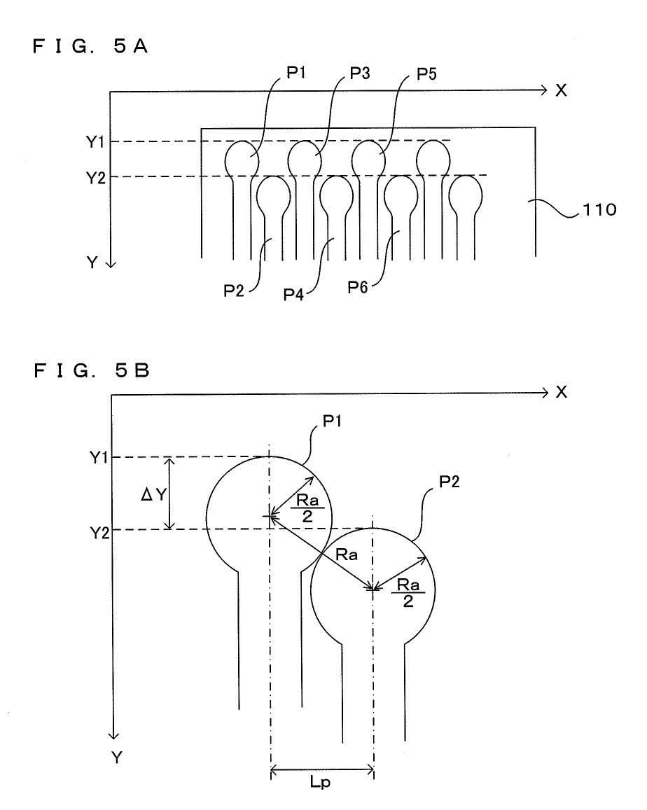

FIGS. 5A and 5B are diagrams which show an example of the active material pattern elements in this embodiment. In view of the above problem, in this embodiment, the start positions of the respective pattern elements in the Y-direction are not aligned and made different in the Y-direction between the adjacent pattern elements as shown in FIG. 5A. More specifically, out of a multitude of active material pattern elements P1, P2, P3, . . . parallel to each other and formed on the base material 110, application is started at a position indicated by a Y coordinate value Y1 for every other pattern elements P1, P3, P5 whose suffix is an odd number, whereas application is started at a position indicated by a Y coordinate value Y2 different from the value Y1 for the remaining pattern elements P2, P4, P6 whose suffix is an even number. By doing so, contact between the adjacent pattern elements resulting from the spread of the pattern elements at the start ends can be avoided.

How far the start positions in the Y-direction between the adjacent pattern elements should be apart is considered with reference to FIG. 5B. Here, a case is assumed where the application liquid discharged from the nozzle 21 and adhered to the base material 110 spreads equi-directionally (circularly when viewed from above) on the surface (X-Y plane) of the base material 110. Actually, the application liquid is extended in a moving direction (Y-direction) of the nozzle 21 and the bulge of the start end is predicted to extend in the Y-direction. Thus, consideration here indicates at least how far the start positions should be apart. Further, the spread amount of each pattern element start end is assumed to be constant and the diameter of the spread is denoted by Ra. Further, Lp denotes an arrangement pitch (distance between the center lines of the pattern elements) of the pattern elements in the X-direction.

FIG. 5B shows a case where the start ends of two pattern elements are most distant in the Y-direction out of cases where the start ends touch each other between two adjacent pattern elements. If a difference ΔY (=Y2−Y1) between the start ends of the two pattern elements in the Y-direction is larger than a relationship shown in FIG. 5B, the two pattern elements do not touch each other. That is, if ΔY>SQR(Ra²−Lp²) from the relationship shown in FIG. 5B, the start ends of the adjacent pattern elements do not touch each other. In the above equation, a function SQR(x) indicates a square root of x. Thus, if the degree of the spread of the application liquid at the start ends and the arrangement pitch of the pattern elements are known, the difference between the start positions of the adjacent pattern elements can be set based on the above equation.

Note that, according to the knowledge of the inventors of this application, an increase amount of the width of the pattern element start end by the spread of the application liquid is at most about 20 to 30% if application conditions such as the viscosity of the application liquid, the opening diameter of the nozzle 21 and a scanning speed are appropriately managed. From this aspect, the difference ΔY between the start positions of the adjacent pattern elements may be simply set to be equal to or more than the arrangement pitch Lp of the pattern elements.

Next, a specific method for forming the above pattern elements by the nozzle-scan coating method is described. For example, the following procedure is thought as a method for forming a multitude of pattern elements parallel to each other with the start ends thereof arranged in a so-called offset manner.

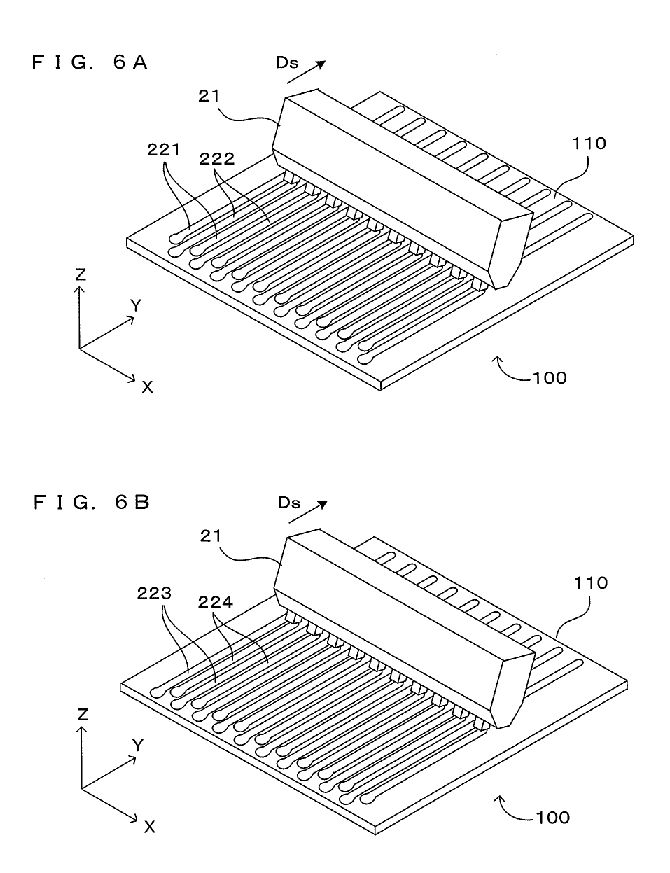

FIGS. 6A and 6B are views which show a first example and a second example of pattern element formation according to this embodiment. Application of the coating method shown in FIG. 3B is, for example, thought for pattern elements whose start positions are arranged in an offset manner as described above. As shown in FIG. 3B, the nozzle 21 in which a multitude of discharge openings for discharging the application liquid are arranged in the X-direction is moved to scan in the Y-direction relative to the surface of the base material 110. By doing so, it is possible to form a plurality of stripe-shaped pattern elements 22 parallel to each other and extending in the Y-direction (first application step). After the plurality of pattern elements are formed in this way, the position of the nozzle 21 in the X-direction relative to the base material 110 is moved by half the arrangement pitch of the already formed pattern elements in the X-direction, i.e. by half the arrangement pitch of the discharge openings of the nozzle 21. Thereafter, by moving of the nozzle 21 in the Y-direction again, one new pattern element can be formed between each pair of already formed pattern elements (second application step). In this way, the pattern elements can be formed at twice as high a density (i.e. ½ arrangement pitch) as before.

At this time, it is possible to form an offset pattern in which the pattern element start ends in the Y-direction alternately differ between the adjacent pattern elements by making the position of the nozzle 21 relative to the base material 110 at the start of application different in the Y-direction. Note that the following two positional relationships can be thought between the pattern elements respectively formed by scanning movements in forward and backward directions.

In the first example shown in FIG. 6A, second application for pattern elements 222 is started from a side upstream (lower left side in FIG. 6A) of the start positions of pattern elements 221 already formed on the surface of the base material 110 by the first scanning in a moving/scanning direction Ds of the nozzle 21. In this case, the application liquid is applied by the second scanning in a direction toward a downstream side between the pattern element start ends formed by the first scanning. In such a case, since the application liquid is applied by the second scanning with a stable width between the already formed pattern elements after spreading at positions away from the already formed pattern elements, contact with the already formed pattern elements caused by the spread of the application liquid can be reliably prevented.

On the other hand, in the second example shown in FIG. 6B, second application for pattern elements 224 is started from a side downstream of the start positions of pattern elements 223 already formed on the surface of the base material 110 by the first scanning in the moving/scanning direction Ds of the nozzle 21. Also in such a case, contact of the application liquid with the already formed pattern elements can be prevented. Further, the tips of the nozzle 21 do not come into contact with and damage the already formed pattern elements when passing between the start ends of the already formed pattern elements.

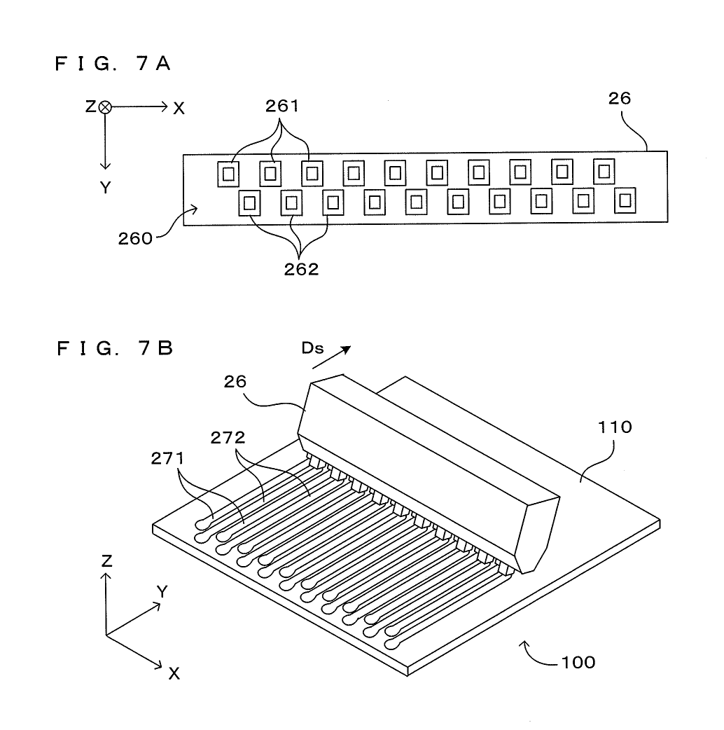

FIGS. 7A and 7B are views which show a third example of pattern element formation according to this embodiment. As shown in FIG. 7A, discharge openings 261, 262 provided in a nozzle 26 are in an offset arrangement. By doing so, it is possible to form pattern elements whose start positions between adjacent pattern elements are in an offset arrangement by one scanning movement of the nozzle 26 relative to the base material 110. Specifically, a first discharge opening row composed of a plurality of first discharge openings 261 arranged at equal intervals in a row in the X-direction is provided on a bottom surface 260 of the nozzle 26. Further, a second discharge opening row composed of a plurality of second discharge openings 262 whose opening positions in the X-direction are different from those of the discharge openings 261 is provided at a position different in the Y-direction from the first discharge opening row.

The nozzle 26 is moved to scan in the scanning direction Ds (Y-direction) relative to the base material 110 while the application liquid is discharged from the respective discharge openings 261, 262 arranged in this manner. This causes a plurality of stripe-shaped pattern elements 271, 272 parallel to each other and having start positions different in the Y-direction between the adjacent pattern elements are simultaneously formed on the base material 110 as shown in FIG. 7B. More specifically, the pattern elements 271 are formed by the application liquid discharged from the first discharge openings 261 and the pattern elements 272 are formed by the application liquid discharged from the second discharge openings 262. That is, in this example, a “first application step” and a “second application step” of the invention are simultaneously performed. Also by such an application method, an electrode 100 having a desired structure can be manufactured.

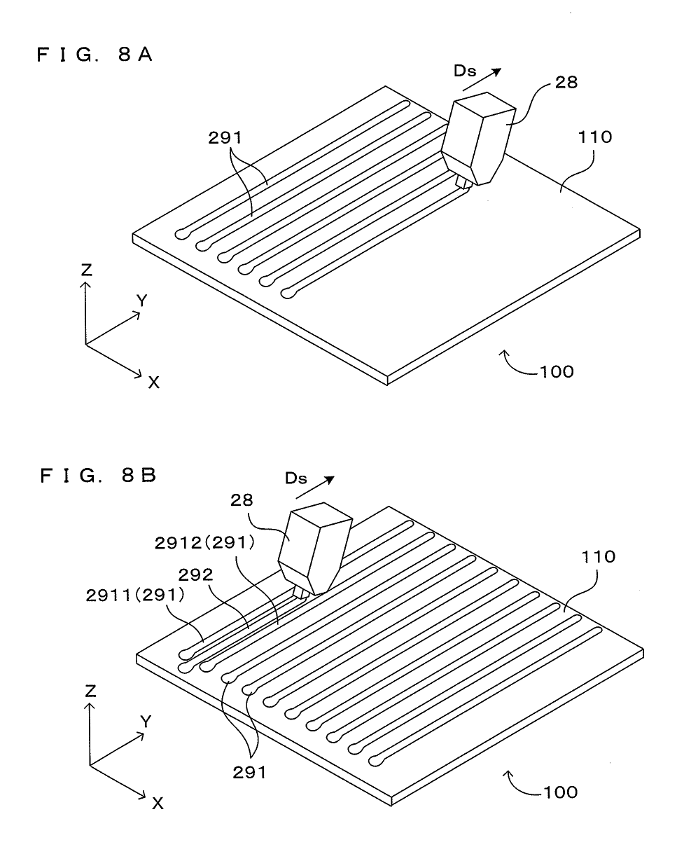

FIGS. 8A and 8B are views which show a fourth example of pattern element formation according to this embodiment. In the above respective examples, a plurality of pattern elements are simultaneously formed using the nozzle in which a plurality of discharge openings is arranged in the X-direction. However, an electrode 100 having a similar configuration can also be manufactured also using a nozzle including a single discharge opening. That is, as shown in FIG. 8A, a plurality of pattern elements 291 parallel to each other and extending in the Y-direction are formed by scan movement of a nozzle 28 having a single discharge opening in the Y-direction every time the position of the nozzle 28 in the X-direction relative to the base material 110 is changed by a constant feed pitch (first application step).

Thereafter, as shown in FIG. 8B, the nozzle 28 is moved to a position which is located between the firstly formed pattern element 2911 and the secondly formed pattern element 2912 and different from the start positions of these pattern elements 2911, 2912 in the Y-direction. The nozzle 28 is moved to scan in the Y-direction every time the position thereof in the X-direction relative to the base material 110 is changed by the same feed pitch as described above (second application step). In this way, new pattern elements 292 can be formed between the already formed pattern elements 291. Similar to the previous example, the start positions of the new pattern elements 292 can be either upstream or downstream of the start positions of the already formed pattern elements 291 in the moving/scanning direction Ds.

Note that, in these application examples, the end positions of the pattern elements are not particularly limited and may be located at the same position in the Y-direction for the following reason. At the end positions of application, notable spread of the pattern elements as at the start positions is not found. Even if contact may be established due to the spread of the pattern elements, the contact is limited to that position and the adjacent pattern elements are not united as shown in FIG. 4D.

As described above, in this embodiment, a plurality of stripe-shaped pattern elements parallel to each other are formed by applying the application liquid containing the active material on the base material. To prevent contact between the pattern elements due to the spread of pattern element start ends in doing this, the pattern element start positions are made different in a pattern element extending direction (nozzle moving/scanning direction) between the adjacent pattern elements. By doing so, active material pattern elements can be formed at narrower intervals than before by preventing a disorder of the pattern element shape resulting from contact of the adjacent pattern elements at the pattern element start ends. As a result, in this embodiment, it is possible to manufacture a battery electrode used to manufacture a battery with good capacity and charge/discharge characteristics.

As described above, in this embodiment, the pattern elements 221 in FIG. 6A, the pattern elements 223 in FIG. 6B, the pattern elements 271 in FIG. 7B, the pattern elements 291 in FIG. 8A and the like correspond to “first active material pattern elements” of the invention. Further, the pattern elements 222 in FIG. 6A, the pattern elements 224 in FIG. 6B, the pattern elements 272 in FIG. 7B, the pattern elements 292 in FIG. 8A and the like correspond to “second active material pattern elements” of the invention.

Note that the invention is not limited to the above embodiment and various changes other than the above can be made without departing from the gist thereof. For example, in the above embodiment, the invention is applied to the method for manufacturing the all-solid-state battery by successively laminating the solid electrolyte layer, the positive-electrode active material layer and the positive-electrode current collector on the negative electrode 10 formed by the method described above. However, the invention can also be applied to a technology for manufacturing a battery not only using such a solid electrolyte, but also an electrolyte layer formed by an electrolytic solution and a technology for manufacturing an electrode for the battery.

Although the active material pattern elements adjacent to each other have the same composition in the above embodiment, there is no limitation to this. A battery in which positive and negative active materials are alternately arranged along a base material surface (see, for example, JP2006-147210A) has been also proposed as a battery including active material pattern elements having a three-dimensional structure besides the above one. The invention can be applied also in manufacturing an electrode used in such a battery. Further, although the invention is applied in manufacturing the negative electrode in the above embodiment, the invention can be, of course, applied in manufacturing a positive electrode.

Further, the materials of the current collectors, the active materials, the electrolyte and the like illustrated in the above embodiment are only examples and there is no limitation to these. Also in the case of manufacturing a lithium-ion battery using other materials used as constituent materials of lithium-ion batteries, the manufacturing method of the invention can be preferably applied. Further, without limitation to lithium-ion batteries, the invention can be applied to manufacturing in general of chemical batteries using other materials and electrodes used therein.

Although a mode of moving and scanning the nozzle relative to the base material is illustrated to facilitate the understanding of the principle of the invention in the above description, relative movements of the base material and the nozzle can be realized by moving either the nozzle or the base material. Rather, in terms of preventing a disorder of application due to vibration applied to the nozzle, it is more preferable to fix the nozzle and move the base material.

Further, in the invention for example, a plurality of active material pattern elements parallel to each other may be formed in the first application step; and the second active material pattern element may be formed between the first active material pattern elements adjacent to each other. By doing so, it is possible to form a plurality of active material pattern elements which are proximate to each other, but do not touch each other, and to manufacture a battery electrode with good performance.

In this case, positions of the nozzle relative to the surface of the base material at the start of application may be made different in the scanning direction and a direction perpendicular thereto between the first application step and the second application step, commonly using the nozzle including a plurality of discharge openings arranged in the direction perpendicular to the scanning direction in the first application step and the second application step. By doing so, it is not necessary to prepare individual nozzles to form the respective first and second active material pattern elements. Further, by making the positions of the nozzle relative to the surface of the base material at the start of application different between the first application step and the second application step, it is possible to easily form a plurality of stripe-shaped pattern elements whose start positions in the scanning direction differ from each other and which extend at different positions in the direction perpendicular to the scanning direction.

Further, the nozzle may include a first discharge opening for forming the first active material pattern element by discharging the application liquid and a second discharge opening for forming the second active material pattern element by discharging the application liquid and the second discharge opening may be provided at a position different from the first discharge opening in the scanning direction and a direction perpendicular thereto; and thereby the first application step and the second application step may be simultaneously performed by moving the nozzle relative to the base material. By providing the nozzle with the discharge openings whose positions differ in the direction perpendicular to the scanning direction, a plurality of active material pattern elements can be simultaneously formed by one scanning movement of the nozzle. At this time, if the positions of the adjacent discharge openings are made different in the scanning direction, the start positions of the pattern elements are made different between the adjacent pattern elements, whereby the object of the invention is achieved.

Particularly, a plurality of first discharge openings and a plurality of second discharge openings may be provided to the nozzle, the first discharge openings and the second discharge openings being respectively arranged in the direction perpendicular to the scanning direction. By doing so, it is possible to form a multitude of pattern elements by one scanning movement of the nozzle and improve throughput of pattern element formation.

Further, the start position of the second active material pattern element may be located upstream of the start position of the first active material pattern element in the scanning direction. In this case, the spread of the application liquid, which will become the second active material pattern element, at the start end part converges and the application liquid is applied with a stable width between the first active material pattern elements previously formed. Thus, a possibility that the spread of the application liquid, which will become the second active material pattern element, leads to contact with the already formed first active material pattern elements is reduced.

Alternatively, the start position of the second active material pattern element may be located downstream of the start position of the first active material pattern element in the scanning direction. In this case, the scanning movement of the nozzle can be started at a position away from the spread of the start end of the first active material pattern element, wherefore a disorder of the pattern elements caused by the contact of the tip of the nozzle with the already formed first active material pattern elements can be prevented.

Further, a distance between the start position of the first active material pattern element and the start position of the second active material pattern element in the scanning direction may be equal to or more than an arrangement pitch of the first active material pattern element and the second active material pattern element adjacent thereto in a direction perpendicular to the scanning direction. Here, an arrangement pitch between the first active material pattern element and the second active material pattern element adjacent thereto can be defined as a distance between the center lines of the respective first and second active material pattern elements in the direction perpendicular to the scanning direction.

The pattern element can spread at the start end in both the scanning direction and the direction perpendicular thereto. The spread is assumed to be of the same degree in the both directions. Then, if the spread width is likely to exceed the arrangement pitch of the pattern elements, i.e. the sum of the supposed-to-be pattern element width and pattern element interval, the pattern element spreads to a position where the adjacent pattern element is supposed to be formed. Thus, to begin with, it is difficult to arrange the pattern elements at such a pitch.

Conversely, if the arrangement pitch is so set that such a problem does not occur, contact of the adjacent pattern elements can be almost reliably avoided when the start positions are made different in the scanning direction by a distance equal to or more than this arrangement pitch.

According to the battery electrode and battery manufacturing methods according to this invention, it is possible to manufacture a battery electrode including a plurality of stripe-shaped active material pattern elements which do not touch each other and are proximately arranged. Therefore, performance such as capacity and charge/discharge characteristics of the battery using this can be improved.

This invention can be preferably applied to a technology for manufacturing a battery electrode using an active material and manufacturing a battery using this electrode and particularly can provide a battery with good capacity and charge/discharge characteristics by forming a plurality of stripe-shaped active material pattern elements at a high density on a base material.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is clamed is:

1. A battery electrode manufacturing method for manufacturing a battery electrode in which a plurality of stripe-shaped active material pattern elements parallel to each other are arranged on a surface of a base material, comprising:
a first application step of applying an application liquid containing an active material in a stripe on the surface of the base material by moving and scanning a nozzle for discharging the application liquid in a predetermined scanning direction relative to the surface of the base material, thereby forming a first active material pattern element; and
a second application step of applying an application liquid containing an active material in a stripe by moving and scanning a nozzle for discharging the application liquid in the scanning direction relative to the surface of the base material, thereby forming a second active material pattern element adjacent to the first active material pattern element, wherein
a start position of the first active material pattern element and a start position of the second active material pattern element are made different in the scanning direction.

2. The battery electrode manufacturing method according to claim 1, wherein:
a plurality of active material pattern elements parallel to each other are formed in the first application step; and
the second active material pattern element is formed between the first active material pattern elements adjacent to each other.

3. The battery electrode manufacturing method according to claim 2, wherein positions of the nozzle relative to the surface of the base material at the start of application is made different in the scanning direction and a direction perpendicular thereto between the first application step and the second application step, commonly using the nozzle including a plurality of discharge openings arranged in the direction perpendicular to the scanning direction in the first application step and the second application step.

4. The battery electrode manufacturing method according to claim 1, wherein:
the nozzle includes a first discharge opening for forming the first active material pattern element by discharging the application liquid and a second discharge opening for forming the second active material pattern element by discharging the application liquid and the second discharge opening is provided at a position different from the first discharge opening in the scanning direction and a direction perpendicular thereto; and
the first application step and the second application step are simultaneously performed by moving the nozzle relative to the base material.

5. The battery electrode manufacturing method according to claim 4, wherein a plurality of first discharge openings and a plurality of second discharge openings are provided to the nozzle, the first discharge openings and the second discharge openings being respectively arranged in the direction perpendicular to the scanning direction.

6. The battery electrode manufacturing method according to claim 1, wherein the start position of the second active material pattern element is located upstream of the start position of the first active material pattern element in the scanning direction.

7. The battery electrode manufacturing method according to claim 1, wherein the start position of the second active material pattern element is located downstream of the start position of the first active material pattern element in the scanning direction.

8. The battery electrode manufacturing method according to claim 1, wherein a distance between the start position of the first active material pattern element and the start position of the second active material pattern element in the scanning direction is equal to or more than an arrangement pitch of the first active material pattern element and the second active material pattern element adjacent thereto in a direction perpendicular to the scanning direction.

9. A battery manufacturing method for manufacturing a battery, comprising:
an electrode manufacturing step of manufacturing an electrode by the battery electrode manufacturing method according to claim 1; and
an electrolyte layer forming step of forming an electrolyte layer covering the active material pattern elements by applying an application liquid containing an electrolyte material to a surface of the electrode where the active material pattern elements are formed.
